(19) United States
(12) Patent Application Publication
(10) Pub. No.: US 2020/0217667 A1
(43) Pub. Date: Jul. 9, 2020

(54) ROBUST ASSOCIATION OF TRAFFIC SIGNS WITH A MAP

(71) Applicant: QUALCOMM Incorporated, San Diego, CA (US)

(72) Inventors: Muryong KIM, Florham Park, NJ (US); Tianheng WANG, San Diego, CA (US); Jubin JOSE, Belle Meade, NJ (US)

(21) Appl. No.: 16/668,596

(22) Filed: Oct. 30, 2019

Related U.S. Application Data
(60) Provisional application No. 62/789,904, filed on Jan. 8, 2019.

(51) Int. Cl. G01C 21/30; G06T 7/73; G06T 3/00

(52) U.S. Cl. CPC G01C 21/30; G06T 2207/30252; G06T 3/0031; G06T 7/73

(57) ABSTRACT

Techniques provide for accurately matching traffic signs observed in camera images with traffic sign data from 3D maps, which can allow for error correction in a position estimate of a vehicle based on differences in the location of the observed traffic sign and the location of the traffic sign based on 3D map data. Embodiments include preparing the data to allow for comparison between observed and map traffic sign data, conducting the comparison in a 2D frame (e.g., in the frame of the camera image) to make an initial order of proximity of candidate traffic signs in the map traffic sign data to the observed traffic sign, conducting a second comparison in a 3D frame (e.g. the frame of the 3D map) to determine an association based on the closest match, and using the association to perform error correction.

### RELATED APPLICATION

This application claims the benefit of U.S. Provisional Application No. 62/789,904, filed Jan. 8, 2019, entitled “ROBUST ASSOCIATION OF TRAFFIC SIGNS WITH MAP,” which is assigned to the assignee hereof and incorporated by reference herein in its entirety.

### BACKGROUND

Vehicle systems, such as autonomous driving and Advanced Driver-Assist Systems (ADAS), often need highly-accurate positioning information to operate correctly. To provide such accurate positioning, ADAS systems may utilize positioning technologies from a variety of sources. For example, Global Navigation Satellite Systems (GNSS) such as Global Positioning System (GPS) and/or similar satellite-based positioning technologies can be used to provide positioning data. This may be enhanced with (or substituted by, where necessary) Visual Inertial Odometry (VIO), which uses data from motion sensors (e.g., accelerometers, gyroscopes, etc.) and one or more cameras to track vehicle movement. These systems can be used to provide a position estimate of the vehicle in a global coordinate system (or “global frame”).

Highly-accurate 3D maps (also known as High Definition (HD) maps) can be used not only to determine where the vehicle is located on a map, but also to increase the accuracy of this position estimate. More specifically, the location of observed visual features on or near a road (e.g., observations of lane markings, traffic signs, etc.) from camera perception can be compared with the location of their counterparts in the 3D map data, and any differences in these locations can be used for error correction of the position estimate. Accurate error correction, therefore, depends on associating a visual feature with the correct map counterpart.

### BRIEF SUMMARY

Techniques provided herein are directed toward accurately associating observed traffic signs from camera images to a counterpart traffic sign within a 3D map. Embodiments include preparing the data to allow for comparison between observed and map traffic sign data, conducting the comparison in a 2D frame (e.g., in the frame of the camera image) to make an initial order of proximity of candidate traffic signs in the map traffic sign data to the observed traffic sign, conducting a second comparison in a 3D frame (e.g. the frame of the 3D map) to determine an association based on the closest match, and using the association to perform error correction.

An example method of vehicle position estimation based on an observed traffic sign and 3D map data for the observed traffic sign, according to this disclosure, comprises obtaining location information comprising Global Navigation Satellite System (GNSS) information, Visual Inertial Odometry (VIO) information, or both, obtaining observation data indicative of where the observed traffic sign is located within an image of the observed traffic sign taken from a vehicle, and obtaining the 3D map data, wherein the 3D map data comprises a location, in a 3D frame, of each of one or more traffic signs in an area in which the vehicle is located. The method further comprises determining a vehicle position estimate based at least in part on the location information, the observation data, and the 3D map data, and providing the vehicle position estimate to a system or device of the vehicle.

An example mobile computing system, according to this disclosure, comprises a memory and a one or more processing units communicatively coupled with the memory. The one or more processing units are configured to obtain location information comprising Global Navigation Satellite System (GNSS) information, Visual Inertial Odometry (VIO) information, or both, obtain observation data indicative of where an observed traffic sign is located within an image of the observed traffic sign taken from a vehicle, and obtain 3D map data, wherein the 3D map data comprises a location, in a 3D frame, of each of one or more traffic signs in an area in which the vehicle is located (e.g., within a threshold distance from the vehicle). The one or more processing units are further configured to determine a vehicle position estimate based at least in part on the location information, the observation data, and the 3D map data, and provide the vehicle position estimate to a system or device of the vehicle.

An example device for estimating vehicle position based on an observed traffic sign and 3D map data for the observed traffic sign, according to this disclosure, comprises means for obtaining location information comprising Global Navigation Satellite System (GNSS) information, Visual Inertial Odometry (VIO) information, or both, means for obtaining observation data indicative of where the observed traffic sign is located within an image of the observed traffic sign taken from a vehicle, and means for obtaining the 3D map data, wherein the 3D map data comprises a location, in a 3D frame, of each of one or more traffic signs in an area in which the vehicle is located. The device further comprises means for determining a vehicle position estimate based at least in part on the location information, the observation data, and the 3D map data, and means for providing the vehicle position estimate to a system or device of the vehicle.

An example non-transitory computer-readable medium, according to this disclosure, has instructions stored thereby for estimating vehicle position based on an observed traffic sign and 3D map data for the observed traffic sign. The instructions, when executed by one or more processing units, cause the one or more processing units to, obtain location information comprising Global Navigation Satellite System (GNSS) information, Visual Inertial Odometry (VIO) information, or both, obtain observation data indicative of where the observed traffic sign is located within an image of the observed traffic sign taken from a vehicle, and obtain the 3D map data, wherein the 3D map data comprises a location, in a 3D frame, of each of one or more traffic signs in an area in which the vehicle is located. The instructions, when executed by one or more processing units, further cause the one or more processing units to determine a vehicle position estimate based at least in part on the location information, the observation data, and the 3D map data, and provide the vehicle position estimate to a system or device of the vehicle.

### BRIEF DESCRIPTION OF THE DRAWINGS

Aspects of the disclosure are illustrated by way of example.

FIG. 1 is a drawing of a perspective view of a vehicle;

FIG. 2 is a block diagram of a position estimation system, according to an embodiment;

FIGS. 3A-3C are illustrations of an overhead view of a vehicle, showing how error correction can improve position estimates, according to an embodiment;

FIG. 4 is an illustration of 3D map data that may be used regarding a traffic sign, according to an embodiment;

FIG. 5 is an illustration of a portion of an image taken by a front-facing camera, according an embodiment;

FIG. 6 is a close-up view of an observed traffic sign and respective corners of the associated map data bounding box, which can be used to determine a difference between the observation and the map data, according to an embodiment;

FIG. 7 is a perspective view of a vehicle and traffic sign, provided as an example to help illustrate the traffic sign association process of the second embodiment.

FIG. 8 is a cross-sectional diagram of a first map data sign plate, second map data sign plate, and line of FIG. 7.

FIG. 9 is a flow diagram of a method of associating an observed traffic sign with 3D map data for the traffic sign, according to an embodiment; and

FIG. 10 is a block diagram of an embodiment of a mobile computing system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc., or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative embodiments will now be described with respect to the accompanying drawings, which form a part hereof. The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

As used herein, the term “position estimate” is an estimation of the location of a vehicle within a frame of reference. This can mean, for example, an estimate of vehicle location on a 2D coordinate frame (e.g., latitude and longitude on a 2D map, etc.) or within a 3D coordinate frame (e.g., latitude, longitude, and altitude (LLA) on a 3D map), and may optionally include orientation information, such as heading. In some embodiments, a position estimate may include an estimate of six degrees of freedom (6DoF) (also known as “pose”), which includes translation (latitude, longitude, and altitude) and orientation (pitch, roll, and yaw) information.

As used herein, the terms “map,” “map data,” and derivatives thereof may refer to an electronic representation of a physical location or geographical area. As a person of ordinary skill in the art will understand, this electronic representation may be stored in a database or other data structure (in any of a variety of storage mediums) as one or more electronic files, data objects, or the like.

It can be noted that, although embodiments described herein below are directed toward determining the position of a vehicle, embodiments are not so limited. Alternative embodiments, for example, may be directed toward other mobile devices and/or applications in which position determination is made. A person of ordinary skill in the art will recognize many variations to the embodiments described herein.

As previously noted, a vehicle position estimate having sub-meter accuracy (e.g., decimeter-level accuracy) within a map can be particularly helpful to an ADAS system for various planning and control algorithms for autonomous driving and other functionality. For example, it can enable the ADAS system to know where the vehicle is located within a driving lane on a road.

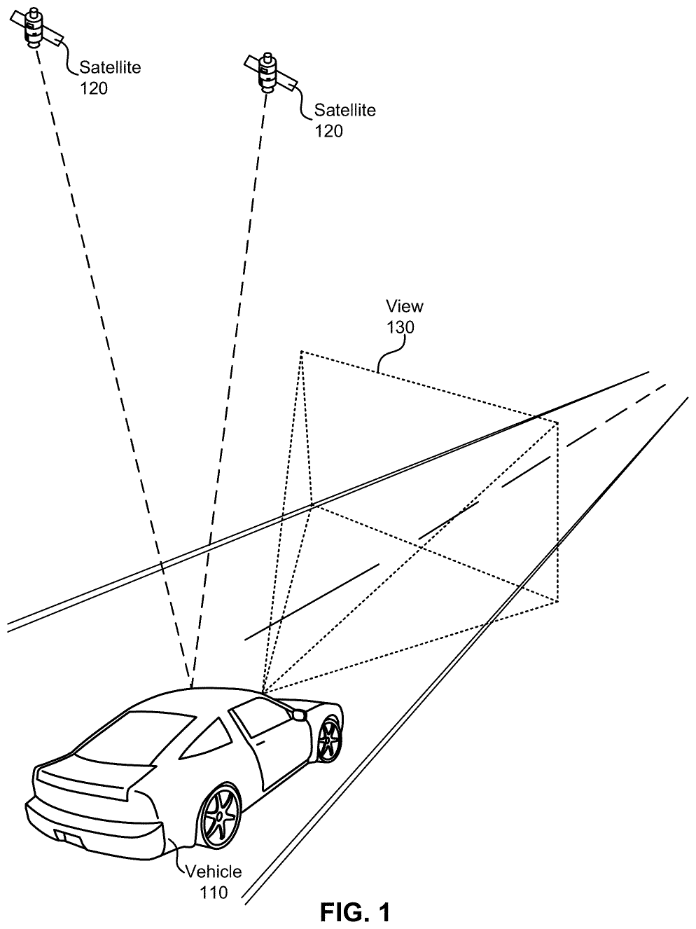

FIG. 1 is a drawing of a perspective view of a vehicle 110, illustrating how sub-meter accuracy may be provided to an ADAS system, according to embodiments. Satellites 120 may comprise satellite vehicles of a GNSS system that provide wireless (e.g., radio frequency (RF)) signals to a GNSS receiver on the vehicle 110 for determination of the position (e.g., using absolute or global coordinates) of the vehicle 110. (Of course, although satellites 120 in FIG. 1 are illustrated as relatively close to the vehicle 110 for visual simplicity, it will be understood that satellites 120 will be in orbit around the earth. Moreover the satellites 120 may be part of a large constellation of satellites of a GNSS system. Additional satellites of such a constellation are not shown in FIG. 1.)

Additionally, one or more cameras may capture images of the vehicle's surroundings. (E.g., a front-facing camera may take images (e.g., video) of a view 130 from the front of the vehicle 110.) Also, one or more motion sensors (e.g., accelerometers, gyroscopes, etc.) disposed on and/or in the vehicle 110 can provide motion data indicative of movement of the vehicle 110. VIO can be used to fuse the image and motion data to provide additional positioning information. This can then be used to increase the accuracy of the position estimate of the GNSS system, or as a substitute for a GNSS position estimate where a GNSS position estimate is not available (e.g., in tunnels, canyons, “urban canyons,” etc.).

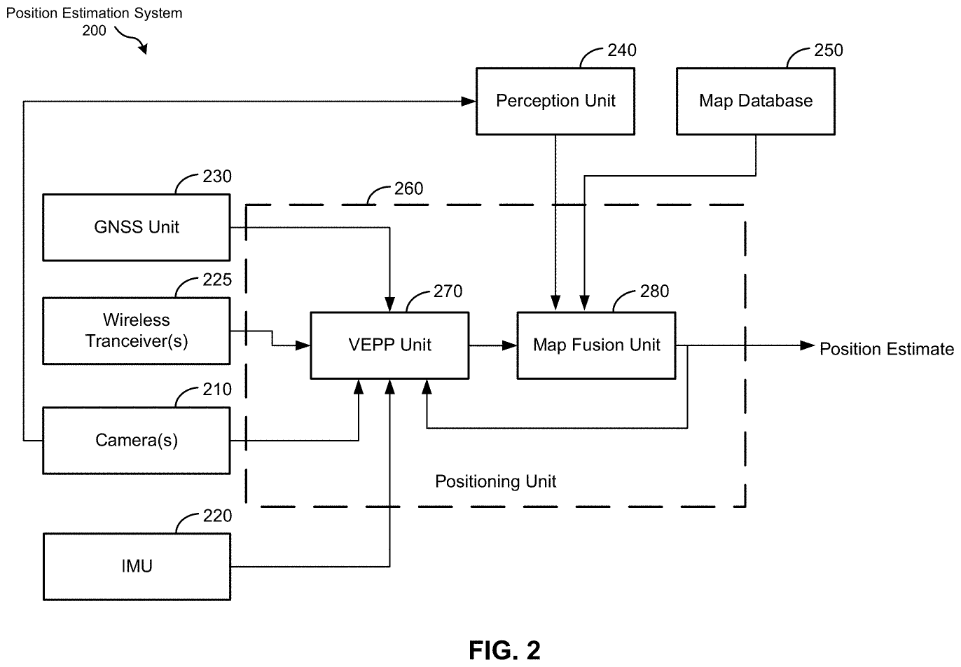

FIG. 2 is a block diagram of a position estimation system 200, according to an embodiment. The position estimation system 200 collects data from various different sources and outputs a position estimate of the vehicle. This position estimate can be used by an ADAS system and/or other systems on the vehicle, as well as systems (e.g., traffic monitoring systems) remote to the vehicle. The position estimation system 200 comprises one or more cameras 210, an inertial measurement unit (IMU) 220, a GNSS unit 230, a perception unit 240, a map database 250, and a positioning unit 260 comprising a vision-enhanced precise positioning (VEPP) unit 270 and a map fusion unit 280.

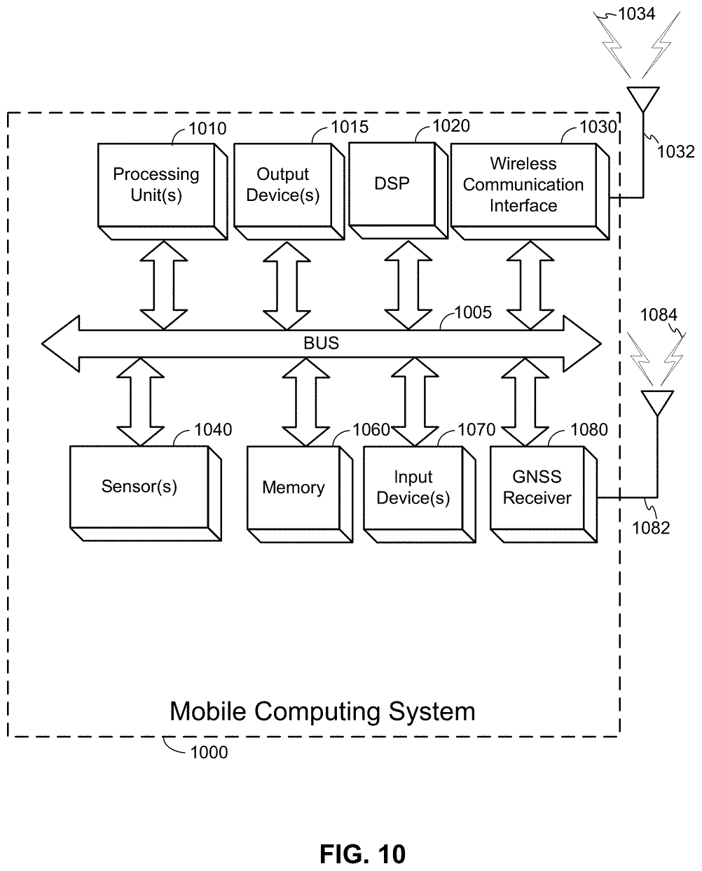

A person of ordinary skill in the art will understand that, in alternative embodiments, the components illustrated in FIG. 2 may be combined, separated, omitted, rearranged, and/or otherwise altered, depending on desired functionality. Moreover, in alternative embodiments, position estimation may be determined using additional or alternative data and/or data sources. One or more components of the position estimation system 200 may be implemented in hardware and/or software, such as one or more hardware and/or software components of the mobile computing system 1000 illustrated in FIG. 10 and described in more detail below. These various hardware and/or software components may be distributed at various different locations on a vehicle, depending on desired functionality. For example, the positioning unit 260 may include one or more processing units.

Wireless transceiver(s) 225 may comprise one or more RF transceivers (e.g., Wi-Fi transceiver, Wireless Wide Area Network (WWAN) or cellular transceiver, Bluetooth transceiver, etc.) for receiving positioning data from various terrestrial positioning data sources. These terrestrial positioning data sources may include, for example, Wi-Fi Access Points (APs) (Wi-Fi signals including Dedicated Source Range Communications (DSRC) signals), cellular base stations (BSes) (e.g., cellular-based signals such as Positioning Reference Signals (PRS) or signals communicated via Vehicle-to-Everything (V2X), cellular V2X (CV2X), or Long-Term Evolution (LTE) direct protocols, etc.), and/or other positioning sources such as road side units (RSUs), etc. In some embodiments, in addition to data from the GNSS unit 230 and VIO (camera(s) 210 and IMU 220) the VEPP unit 270 may use such data from the wireless transceiver(s) 225 to determine a position determination by fusing data from these data sources.

The GNSS unit 230 may comprise a GNSS receiver and GNSS processing circuitry configured to receive signals from GNSS satellites (e.g., satellites 120) and GNSS-based positioning data. The positioning data output by the GNSS unit 230 can vary, depending on desired functionality. In some embodiments, the GNSS unit 230 will provide, among other things, a three-degrees-of-freedom (3D3DoF) position determination (e.g., latitude, longitude, and altitude). Additionally or alternatively, the GNSS unit 230 can output the underlying satellite measurements used to make the 3D3DoF position determination. Additionally, or alternatively, the GNSS unit can output raw measurements, such as pseudo-range and carrier-phase measurements.

The camera(s) 210 may comprise one or more cameras disposed on or in the vehicle, configured to capture images, from the perspective of the vehicle, to help track movement of the vehicle. The camera(s) 210 may be front-facing, upward-facing, backward-facing, downward-facing, and/or otherwise positioned on the vehicle. Other aspects of the camera(s) 210, such as resolution, optical band (e.g., visible light, infrared (IR), etc.), frame rate (e.g., 30 frames per second (FPS)), and the like, may be determined based on desired functionality. Movement of the vehicle 110 may be tracked from images captured by the camera(s) 210 using various image processing techniques to determine motion blur, object tracking, and the like. The raw images and/or information resulting therefrom may be passed to the VEPP unit 270, which may perform a VIO using the data from both the camera(s) 210 and the IMU 220.

IMU 220 may comprise one or more accelerometers, gyroscopes, and/or (optionally) other sensors, such as magnetometers, to provide inertial measurements. Similar to the camera(s) 210, the output of the IMU 220 to the VEPP unit 270 may vary, depending on desired functionality. In some embodiments, the output of the IMU 220 may comprise information indicative of a 3D3DoF position or 6DoF pose of the vehicle 110, and/or a 6DoF linear and angular velocities of the vehicle 110, and may be provided periodically, based on a schedule, and/or in response to a triggering event. The position information may be relative to an initial or reference position. Alternatively, the IMU 220 may provide raw sensor measurements.

The VEPP unit 270 may comprise a module (implemented in software and/or hardware) configured to perform of VIO by combining data received from the camera(s) 210 and IMU 220. For example, the data received may be given different weights based on input type, a confidence metric (or other indication of the reliability of the input), and the like. VIO may produce an estimate of 3D3DoF position and/or 6DoF pose based on received inputs. This estimated position may be relative to an initial or reference position. As noted above, the VEPP unit 270 may additionally or alternatively use information from the wireless transceiver(s) 225 to determine a position estimate.

The VEPP unit 270 can then combine the VIO position estimate with information from the GNSS unit 230 to provide a highly-accurate vehicle position estimate in a global frame to the map fusion unit 280. The map fusion unit 280 works to provide a vehicle position estimate within a map frame, based on the position estimate from the VEPP unit 270, as well as information from a map database 250 and a perception unit 240. The map database 250 can provide a 3D map (e.g., a high definition (HD) map in the form of one or more electronic files, data objects, etc.) of an area in which the vehicle 110 is located, and the perception unit 240 can make observations of lane markings, traffic signs, and/or other visual features in the vehicle's surroundings. To do so, the perception unit 240 may comprise a feature-extraction engine that performs image processing and computer vision on images received from the camera(s) 210.

According to embodiments, the map data received from the map database 250 may be limited to conserve processing and storage requirements. For example, map data provided from the map database 250 to the map fusion unit 280 may be limited to locations within a certain distance around the estimated position of the vehicle 110, locations within a certain distance in front of the estimated position of the vehicle 110, locations estimated to be within a field of view of a camera, or any combination thereof.

The position estimate provided by the map fusion unit 280 (i.e., the output of the positioning unit 260) may serve any of a variety of functions, depending on desired functionality. For example, it may be provided to ADAS or other systems of the vehicle 110 (and may be conveyed via a controller area network (CAN) bus), communicated to devices separate from the vehicle 110 (including other vehicles; servers maintained by government agencies, service providers, and the like; etc.), shown on a display of the vehicle (e.g., to a driver or other user for navigation or other purposes), and the like.

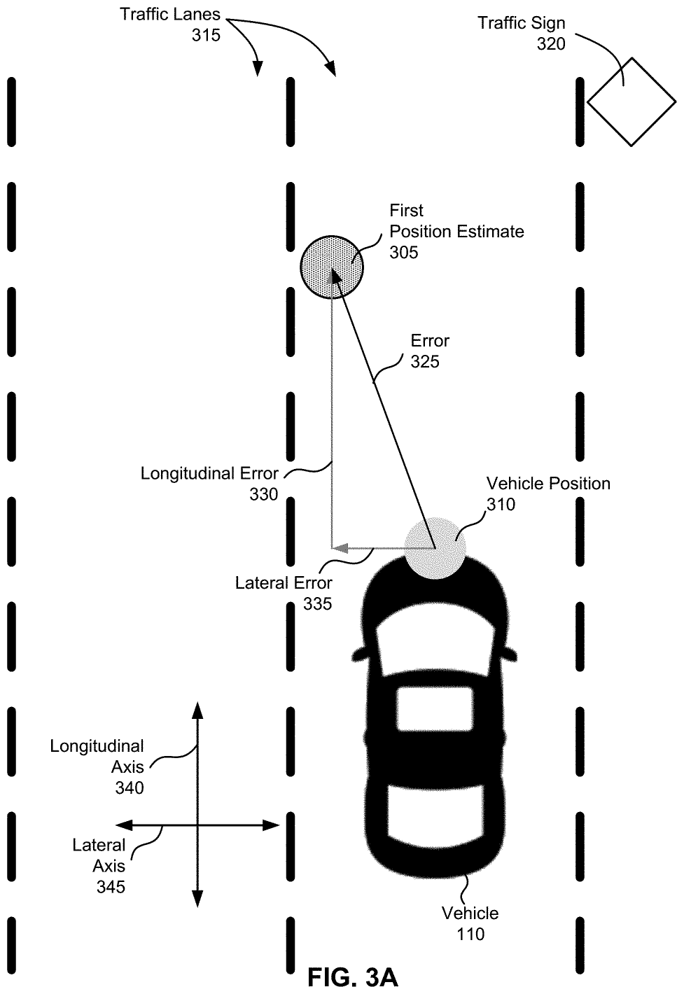

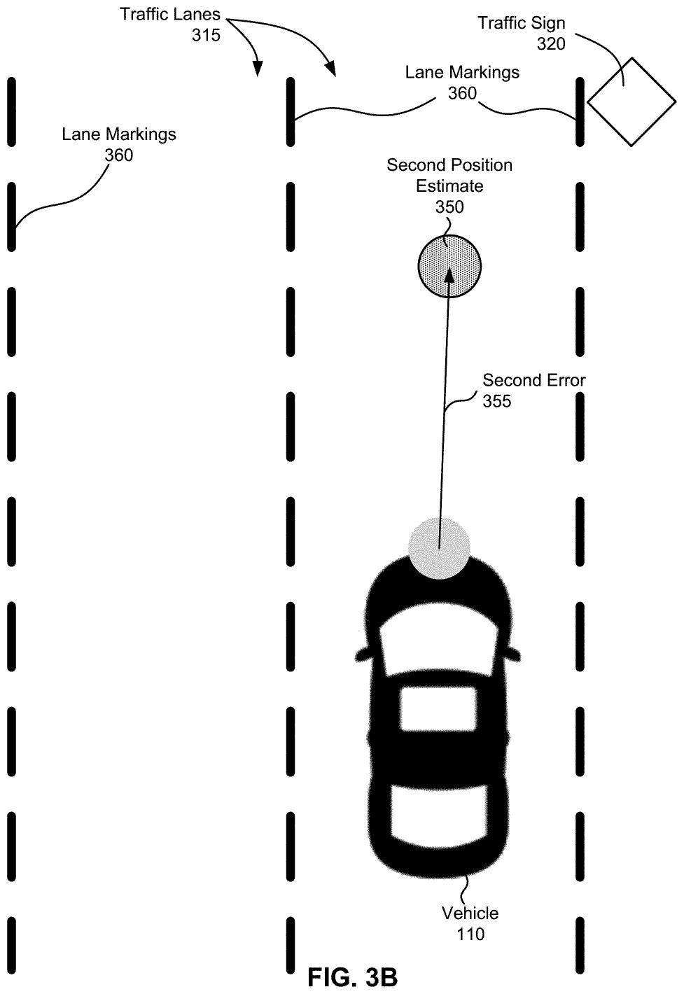

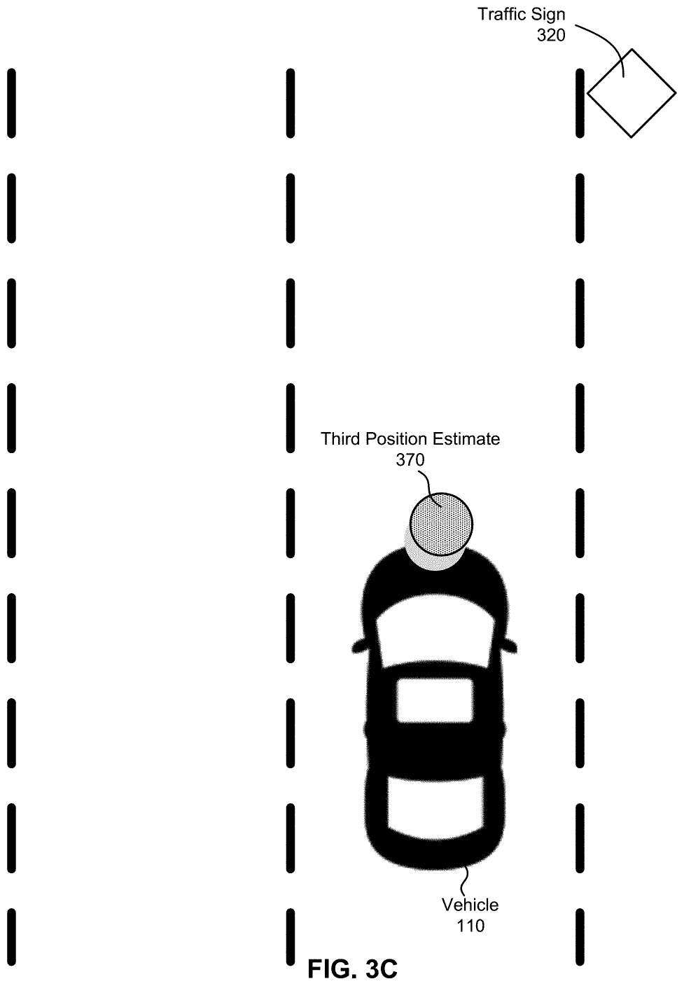

FIGS. 3A-3C are simplified overhead views a vehicle 110, illustrating an example first position estimate 305 for a vehicle 110, and how error correction can improve the position estimate, according to an embodiment. Here, the first position estimate 305 and subsequent position estimates are intended to estimate a vehicle position 310 located at the front of the vehicle 110. (It can be noted that, alternative embodiments may use a different convention for where the vehicle position 310, is located on the vehicle 110.)

FIG. 3A illustrates the vehicle 110 driving in the right-hand lane of a road with two traffic lanes 315 and a nearby traffic sign 320. The first position estimate 305 is the position estimate provided by the VEPP unit 270 to the map fusion unit 280, and thereby may be based on GNSS and/or VIO position estimates.

As can be seen, the first position estimate 305 does not truly reflect the vehicle position 310. The distance between the first position estimate 305 and the vehicle position 310 is the error 325 in the position estimate. Error 325 can be broken down into longitudinal error 330 and lateral error 335.

As previously noted, “longitudinal” and “lateral” directions may be based on a coordinate system that has a longitudinal axis 340 in the direction of the lane 315 in which the vehicle 110 is located, and a lateral axis 345 perpendicular to the longitudinal axis 340, where both axes are in the plane of the surface on which the vehicle 110 is located. Alternatively, longitudinal and lateral directions may be based on the vehicle's heading. (Under most circumstances, axes based on the direction of the lane 315 are substantially the same as axes based on the vehicle's heading.) Other embodiments may determine longitudinal and lateral directions in other ways.

FIG. 3B illustrates updated second position estimate 350 that can be the result of lateral error correction that can reduce or eliminate lateral error 335 (FIG. 3A), of the first position estimate 305 according to embodiments. As such, the second error 355 for the second position estimate 350 may have little or no lateral error. Lateral error correction can be based on the traffic sign 320 and/or lane markings 360 near the vehicle 110, for example. Because lane markings 360 are disposed laterally across the field of view of a camera located on the vehicle, they can be particularly useful in lateral error correction. (Although illustrated as dashed lines, various types of lane markings 360 can be identified and used for error correction, including bumps, dots, and/or solid lines.)

FIG. 3C illustrates a third position estimate 370 that can be the result of both latitudinal and longitudinal error correction, according to embodiments. Longitudinal error correction also can be based on the traffic sign 320 and/or lane markings 360 near the vehicle 110. Because the traffic sign 320 offers depth information, it can be particularly useful in longitudinal error correction.

As previously noted, although lane markings 360 in an image may provide some information that can be used to correct longitudinal error 330 (FIG. 3A), other objects captured within an image can provide more information regarding depth, and thus, may be particularly helpful in correcting the longitudinal error 330. Referring again to FIG. 3A, for example, a location of the traffic sign 320 relative to the vehicle, as observed in an image, can be compared with a location of the traffic sign within a 3D map to determine an error between the observed vehicle position and a position estimate. Accordingly, embodiments may utilize traffic signs for longitudinal error correction. That said embodiments additionally or alternatively may utilize traffic signs for other error correction (e.g., latitude and/or altitude), depending on desired functionality.

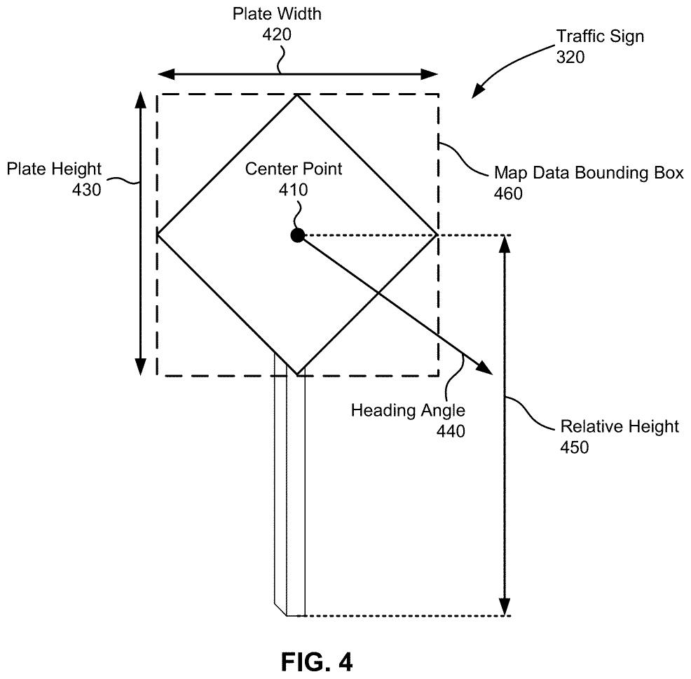

FIG. 4 is an illustration of 3D map data that can be provided regarding a traffic sign 320, according to some embodiments. This includes a center point 410, a plate width 420, a plate height 430, a heading angle 440, and a relative height 450 (from the ground to the center point 410). This information provides a map data bounding box 460 that can be used for traffic sign association and position estimate error correction, described in detail below. (The map data bounding box 460 itself may be included in the 3D map data, or may be derived from the other information provided.)

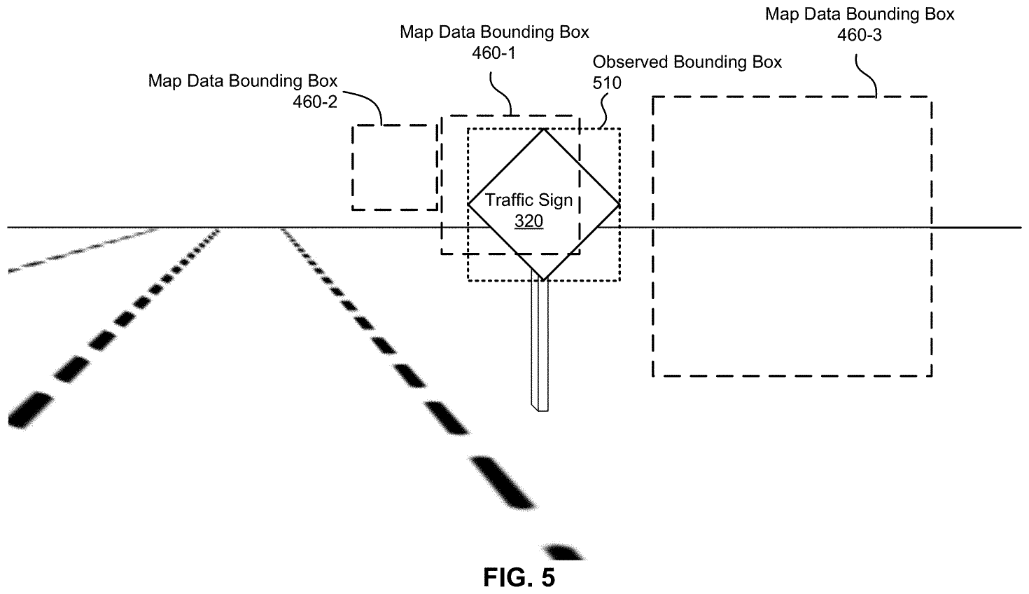

It will be understood, however, that in alternative embodiments, the 3D map data (e.g., as stored and/or provided by the map database 250) may comprise additional or alternative information. Different types of traffic signs may vary in size, shape, location, and other characteristics. The information regarding the traffic sign 320 provided in the 3D map data may depend on the source of the 3D map data. Currently, there are various commercial sources for 3D map data, and specific information regarding traffic signs may vary from source to source. FIG. 5 indicates how this 3D map data may be associated with a traffic sign 320 captured in an image.

FIG. 5 is an illustration of a portion of an image taken by a vehicle's front-facing camera, according to an embodiment. The image includes a traffic sign 320 to be associated with a counterpart traffic sign in the 3D map data. (Bounding boxes 460 and 510, which are used to make the association, are not part of the underlying image.) Different embodiments for traffic sign association are provided below. In general, the final best match traffic sign in the map can be determined based on a combination of intersection-over-union, distance in pixels, and distance in meters.

According to a first embodiment, to make the association between 3D map data and an observed traffic sign 320 robust, the association can be performed in two phases: comparison in the 2D coordinate system (e.g., the coordinate system of the camera image), and a final association based on a comparison within a 3D coordinate system. The overall process comprises:
1. Data preparation,
2. Comparison of the observed traffic sign with traffic sign map data in a 2D frame, to provide a priority of traffic sign map data based on similarity,
3. Comparison of the traffic sign in a 3D frame, based on the priority from the comparison in the 2D frame, and
4. Using association results for Extended Kalman Filter (EKF) tracking.

With regard to data preparation (Step 1), the perception unit 240 (FIG. 2) can extract visual information regarding each of the traffic signs 320. The information extracted can vary, and may be extracted to replicate traffic sign information provided in the 3D map data (e.g., as illustrated in FIG. 4 and described above). Example data extracted by the perception unit 240 may comprise coordinates (e.g., Latitude, Longitude, and Altitude (LLA coordinates)) of the traffic sign plate center point, the width and height of the traffic sign plate, the heading angle of the traffic sign plate, the shape of the traffic sign plate (rectangle, triangle, diamond, etc.), and so forth.

Additionally or alternatively, observed bounding boxes around the traffic sign plates (which may be described by their four corners) can be extracted from the image data. Observed bounding box 510 for the traffic sign 320 is illustrated in FIG. 5. This observed bounding box 510 may be determined by the perception unit 240, or may be determined by the map fusion unit 280 based on other traffic sign data provided by the perception unit 240. Although the examples that follow use bounding boxes as the data compared between the map data and the observed data, other types of data (e.g., shape, width, height, heading angle, etc.) can be used similarly.

The map data bounding boxes 460-1, 460-2, and 460-3 (collectively and generically referred to herein as map data bounding boxes 460) represent locations, within the 3D map data, of respective traffic signs, which are superimposed on the image shown in FIG. 5, based on a position estimate of the vehicle 110 within the 3D map data (e.g., in the first position estimate 305). FIG. 5 illustrates how the map data bounding box 460 itself may be compared with observed bounding boxes 510 to make the association.

Because there are multiple map data bounding boxes 460, each is a candidate to which the traffic sign 320 may be associated. The correct association can result in accurate error correction for the position estimate, while an incorrect association can result in poor error correction. It can be noted that, in some situations, multiple traffic signs 320 (and thus, multiple observed bounding boxes 510) may exist.

According to some embodiments, a process for making an association of an observed traffic sign with traffic sign map data in a 2D frame (Step 2 above) may proceed as follows.

First, determine traffic signs 320 in an observed image with which to compare 3D map data for a traffic sign. Embodiments may ignore traffic signs that are far away (e.g., having observed bounding boxes 510 smaller than a particular threshold), focusing instead on nearby traffic signs 320.

Second, determine the map data bounding boxes 460 (or other data used to associate map data with observed data) for nearby traffic signs within the 3D map data. According to some embodiments, 3D map data information for traffic signs may be extracted if the traffic signs are within a threshold distance from the estimated position of the vehicle 110.

Third, project the map data bounding boxes 460 onto the image plane of the camera used to make the observations from which the observed bounding boxes 510 or extracted (e.g., by superimposing the map data bounding boxes 460 on the image, as shown in FIG. 5). The locations of the map data bounding boxes 460, when projected on to the 2D image, are based on a position estimate of the vehicle 110.

Finally, compare the observed bounding box 510 of the traffic sign 320 with of the candidate map data bounding boxes 460. The match having the closest distance between like features (e.g., average distance between corners of the compared bounding boxes) is most likely to be the correct match. Thus, the process may provide an order of likely candidates for association, based on the proximity of each candidate map data bounding box 460 to the observed bounding box 510. (In FIG. 5, the map data bounding box 460-1 would likely be listed first.) Ordering candidate map data bounding boxes 460 in this manner prioritizes 3D comparisons, which can increase speed and efficiency of the 3D comparisons. The 3D comparisons are made to avoid possible wrong association.

When comparing the map data with the observed data (bounding boxes or other data) any of a variety of similarity measures may be used, such as intersection-over-union (IOU), the sum of squared distance in pixels, or the like. Embodiments may utilize one or more such similarities, as desired.

Where multiple comparisons are made between one or more map data bounding boxes 460 and one or more traffic signs 320, optimizations may be made to reduce the amount of comparisons. For example, if a first observed bounding box 510 is determined to be closer to the vehicle 110 than a second observed bounding box 510, and a first map data bounding box 460 is associated to the first observed bounding box 510, then the process may omit comparing a second map data bounding box 460 with the second observed bounding box 510 if the second map data bounding box 460 is closer to the vehicle 110 than the first map data bounding box 460. Other optimizations may be made similarly.

Comparison of the observed bounding box 510 with map data bounding boxes 460 in a 3D frame (Step 3 above) (e.g., in the order provided by the comparison in 2D) can be done by projecting observed bounding boxes 510 onto a plane within the 3D frame. Specifically, observed bounding box 510 can be expressed in a 3D (e.g., east, north, up (ENU)) coordinate system by projecting the observed bounding box 510 onto a plane of the map data bounding box 460 (i.e., the plane of the traffic sign plate within the 3D map data) for each of the candidate map data bounding boxes 460. The plane of the traffic sign can be determined from the plane equation, where coordinates of the map data bounding box (e.g., the points on three of the four corners) are used. Once the observed bounding box 510 is projected onto the plane of a respective map data bounding box 460, the observed bounding box 510 can then be compared with the respective map data bounding box 460 using techniques similar to the techniques used to measure similarity in 2D (e.g., IOU, the sum of squared distance, or the like). Because the comparison is made in 3D, distances may be measured in meters, rather than pixels (as may be the case in 2D), and the comparison can be more accurate because he can take into account differences in the distances in the planes of the respective map data bounding boxes. Thus, the 3D comparison may be the final decision step to determine the closest match (of the map data bounding boxes 460 with the observed bounding box 510) in terms of physical distance in 3D space, and the previously-performed 2D comparison may help streamline this process by providing an order of which candidate map data bounding boxes 460 are closest to the observed bounding box 510 based on distance in pixels.

If it is determined from 3D comparison that the map data bounding box 460 with the best fit in 2D is not within a threshold distance (or other similarity metric) from the observed bounding box 510, a second 3D comparison can be made (e.g., between the observed bounding box 510 and the map data bounding box 460 with the next-best fit in 2D) and subsequently compared in 3D.

Using association results for Extended Kalman Filter (EKF) tracking (Step 4 above) can involve refining the observed location of the traffic sign 320 over time, based on multiple observations. Depending on the speed of the vehicle 110 and the frame rate at which images are captured and associations of all observed image features with 3D map data as described above are made, the process described above can be made multiple times (e.g., dozens, hundreds, etc.) for a single traffic sign 320 as the vehicle 110 drives past the traffic sign 320. Because the vehicle's estimated position is tracked by some Bayesian filter such as EKF, the new orientation angles can be used as an observation vector to update the filter states. The refined positioning result feeds back to VEPP unit 270 to be used in the next iteration (i.e., used for a subsequent position estimate).

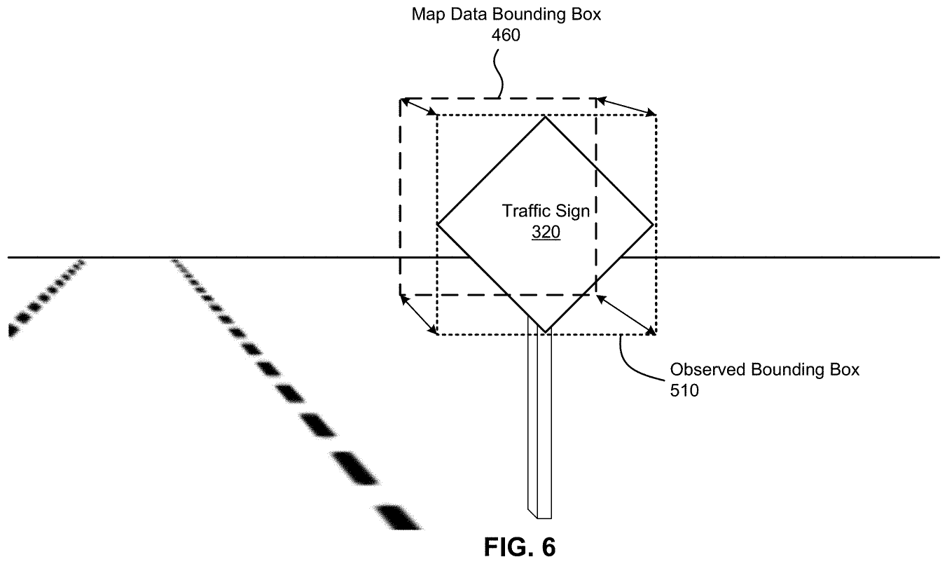

FIG. 6 is a close-up view of the traffic sign 320 of FIG. 5, showing how distances between corners of the observed bounding box 510 for the traffic sign 320 and respective corners of the associated map data bounding box 460. This can be used, for example, to determine a difference between the observation and the map data. In turn, the determined distance can be used for error correction. For example, an EKF can determine a second vehicle position estimate based on the following equation:

μₜ=μ̅ₜ+Kₜ(zₜ−h(μ̅ₜ), (1)

where μ̅ₜ is the position estimate (e.g., 6DoF pose) before adjusting for the observed bounding box 510, μₜ is the second position estimate in view of the observed bounding box 510, Kₜ is the Kalman gain, zₜ is the location of the observed bounding box 510, and h(μ̅ₜ) is the location of the associated map data bounding box 460.

According to a second embodiment, the association between 3D map data and an observed traffic sign 320, can be made using a least square approach, which directly performs association in a 3D (e.g., ENU) frame, and can be particularly accurate in many applications. In this embodiment, the process includes, for each traffic sign observed in an image, finding the best match in the 3D map data by:
1. Given a point observation (e.g., the center of traffic sign plate) in image frame, determining a line in the 3D frame that satisfies this point observation, based on camera pose (position and orientation) and calibration information.
2. For each candidate traffic sign in the 3D map data, determine if the above-mentioned line passes through the traffic sign plate. If not, the traffic sign can be removed from the candidate list.
3. For each candidate traffic sign still in the list, calculate a point-to-line distance between the line and the traffic sign center in 3D frame.
Identify the traffic sign that gives shortest point-to-line distance, and associate the identified traffic sign with the traffic sign in the image.

Similar to the data preparation step of the first embodiment (described above), the perception unit 240 (FIG. 2) can be used in Step 1 of this embodiment can be used to obtain an image of a traffic sign from a camera 210 and determine the point observation of a traffic sign, then projects that point into the 3D space.

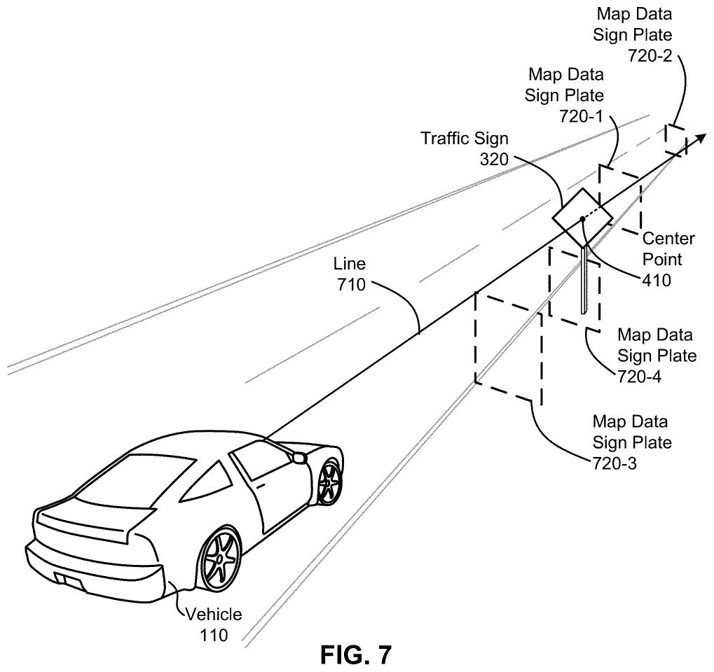

FIG. 7 is a perspective view of a vehicle 110 and traffic sign 320, provided as an example to help illustrate the traffic sign association process of the second embodiment. Here, a camera of the vehicle 110 captures an image of the traffic sign 320, from which the center point 410 of the traffic sign 320 is extracted (e.g., from the perception unit 240).

Once the center point 410 (or some other observation point on the traffic sign 320) is determined, it can be projected into the frame of the 3D map data as a line 710, based on camera pose information (location and orientation) and calibration information. Pose information of the camera can be based, for example, on a pose estimation of the vehicle 110 (which may be continually determined, as described above with regard to FIG. 2) and information regarding the relative location and orientation of the camera with respect to the vehicle 110. When projected into the 3D frame, the line passes from the camera and center point 410 of the traffic sign 320, and beyond. (Depending on how it is determined, it may also continue backward behind the vehicle 110.)

The position of the line 710 in the 3D frame can then be compared with the positions of candidate traffic signs in the 3D map data within a threshold distance of the vehicle 110. It can be noted that although FIG. 7 shows the positions of the candidate traffic signs as map data sign plates 720, bounding boxes of traffic sign plates may be used additionally or alternatively, in some embodiments.

As noted above, the number of candidate traffic signs can be reduced, based on whether the line 710 intersects with the location of the corresponding map data sign plate 720. That is, for each candidate traffic sign, a comparison is made of the location of its corresponding map data sign plate and the location of the line 710. If the line intersects the map data sign plate 720, the corresponding candidate traffic sign remains a candidate. Otherwise, if the line does not intersect with the map data sign plate 720, the corresponding candidate traffic sign is no longer considered a candidate traffic sign. In FIG. 7, for example, because the line 710 passes through a first map data sign plate 720-1 and second map data sign plate 720-2, the candidate traffic signs corresponding to these map data sign plates are still considered candidate traffic signs. Furthermore, because the line 710 does not pass through a third map data sign plate 720-3 and fourth map data sign plate 720-4, the candidate traffic signs corresponding to these map data sign plates are removed from consideration as traffic signs in the 3D map data with which to associate the observed traffic sign 320.

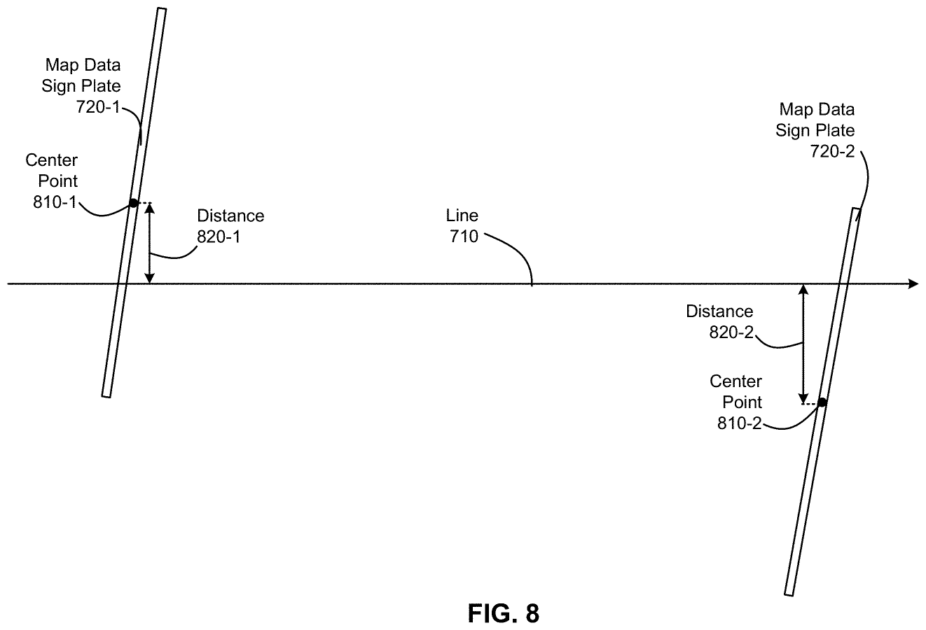

The map data sign plates 720 for the candidate traffic signs remaining can then be compared with the line 710 to determine the candidate traffic sign with which the observed traffic sign 320 can be associated. FIG. 8 provides an example.

FIG. 8 is a cross-sectional diagram of the first map data sign plate 720-1, second map data sign plate 720-2, and line 710 of FIG. 7. According to some embodiments, each map data sign plate 720, the respective center point 810 can be determined and compared with the line 710 to determine the candidate traffic sign in the 3D map data with which to associate the observed traffic sign 320. According to some embodiments, the distance 820 between the center point 810 and is a line 710 is determined. More specifically, the distance 820 may be a point-to-line distance, determined in the 3D frame, between the center point 810 of a map data sign plate 720 and the line 710.

Once the distance is 820 have been determined, the candidate traffic sign having the shortest distance 820 can be identified and associated with the observed traffic signs 320. In the example illustrated in FIG. 8, for instance, a first distance 820-1 between the center point 810-1 of the first map data sign plate 720-1 is shorter than a second distance 820-2 between the center point 810-2 of the second map data sign plate 720-2. Thus, the 3D map data of the candidate traffic sign corresponding to the map data sign plate 720-1 can then be associated with the observed traffic sign 320.

The algorithms used to perform the steps of the second embodiment described above and illustrated in FIGS. 7 and 8 may vary, depending on desired functionality. According to some embodiments, the relation between a 3D point vₙ in the 3D map data frame and a 2D image point vᵢ may be given by:

vᵢ=f(KR_{nc}^{T}(vₙ−T_{nc}), (2)

where K is a camera intrinsic matrix, and T_{nc} and R_{nc} are camera position and orientation axes in the 3D frame, respectively.

Further, for a point:

$$v = [ \begin{matrix}{v}_{1} \\ {v}_{2} \\ {v}_{3}\end{matrix} ] , \qquad ( 3 )$$

the function f(·) is defined by:

$$f ( v ) = [ \begin{matrix}{v}_{1} / {v}_{3} \\ {v}_{2} / {v}_{3}\end{matrix} ] . \qquad ( 4 )$$

since the function f(·) is a 3D-to-2D mapping, it is not invertible.

The 3D line in the 3D frame that satisfies the point observation v₁ and includes vₙ can then be determined. A point \hat{v}ₙ on this line, parameterized by a, can be described by:

\hat{v}ₙ=T_{nc}+αR_{nc}K⁻¹[₁^{v}^{ᵢ}]. (5)

Given a traffic sign center point vₘ from the map in the 3D frame, a minimum distance point on the line can be found by:

$${min}_{∝} {‖ {\hat{v}}_{n} - {v}_{m} ‖}^{2} = {min}_{∝} {‖ {T}_{n c} - {v}_{m} + α {R}_{n c} {K}^{- 1} [ \begin{matrix}{v}_{i} \\ 1\end{matrix} ] ‖}^{2} . \qquad ( 6 )$$

The objective function is a quadratic in the form ∥p+αh∥² where:

$$\begin{matrix}p = {T}_{n c} - {v}_{m} & ( 7 ) \\ h = {R}_{n c} {K}^{- 1} [ \begin{matrix}{v}_{i} \\ 1\end{matrix} ] . & ( 8 )\end{matrix}$$

Having this, the optimal α can then be found by differentiating (p+αh)^{T}(p+αh) with respect to α and setting it to zero:

$${α}^{*} = - \frac{{p}^{T} h}{{‖ h ‖}^{2}} = - \frac{{( {T}_{n c} - {v}_{m} )}^{T} {R}_{n c} {K}^{- 1} [ \begin{matrix}{v}_{i} \\ 1\end{matrix} ]}{{‖ {R}_{n c} {K}^{- 1} [ \begin{matrix}{v}_{i} \\ 1\end{matrix} ] ‖}^{2}} \qquad ( 9 )$$

Finally, given candidate traffic signs [symbol] ={1, . . . , M} from the 3D map data, the candidate traffic sign with the smallest minimum distance can be found by:

$${min}_{m ∈ M} ‖ {T}_{n c} - {v}_{m} + {α}^{*} {R}_{n c} {K}^{- 1} [ \begin{matrix}{v}_{i} \\ 1\end{matrix} ] ‖ . \qquad ( 10 )$$

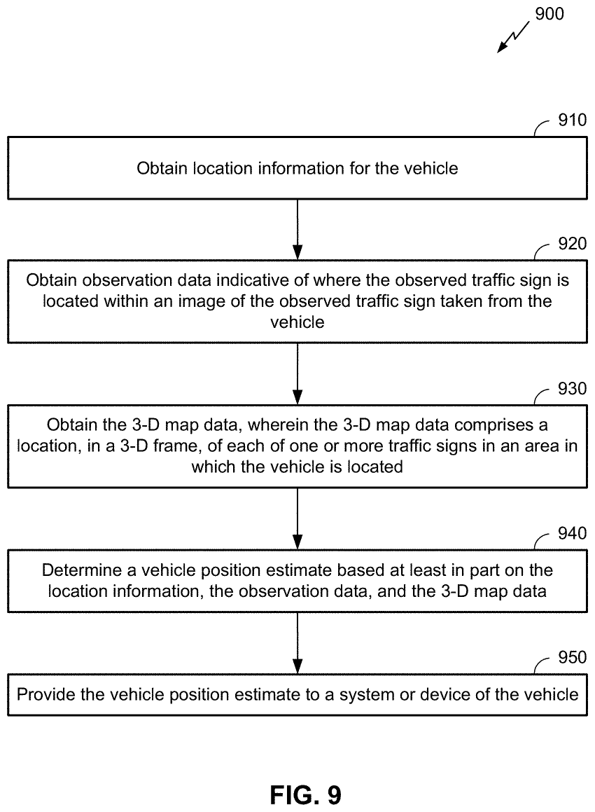

FIG. 9 is a flow diagram of a method 900 of method of associating an observed traffic sign with 3D map data for the traffic sign, according to an embodiment. Alternative embodiments may perform functions in alternative order, combine, separate, and/or rearrange the functions illustrated in the blocks of FIG. 9, and/or perform functions in parallel, depending on desired functionality. A person of ordinary skill in the art will appreciate such variations. Means for performing the functionality of one or more blocks illustrated in FIG. 9 can include a map fusion unit 280 or, more broadly, a positioning unit 260, for example. Either of these units may be implemented by a processing unit and/or other hardware and/or software components of an on-vehicle computer system, such as the mobile computing system 1000 of FIG. 10, described in further detail below.

At block 910, location information for the vehicle is obtained. As noted, this location information may comprise GNSS information, VIO information, wireless terrestrial location information (e.g., information enabling the determination of the location of the vehicle from terrestrial wireless sources), or any combination thereof. As previously noted, this information may include a first vehicle position estimate. Additionally or alternatively, this information may comprise underlying GNSS and/or VIO information that can be used to obtain a position estimate. Means for performing the functionality of block 910 may include a bus 1005, processing unit(s) 1010, wireless communication interface 1030, GNSS receiver 1080, sensor(s) 1040, memory 1060, and/or other components of a mobile computing system 1000 as illustrated in FIG. 10 and described in further detail below.

According to some embodiments, location information may comprise other positioning information from other sources such as Wi-Fi signals and/or cellular-based signals (e.g., using positioning based on cell-ID, enhanced cell-ID, Observed Time Difference Of Arrival (OTDOA) and/or other techniques using PRS, etc.) other positioning data received from road side units (RSUs) or other vehicles or other entities. Sensor-based and/or sensor-assisted location determination such as dead reckoning additionally or alternatively may be used. Accordingly, the first vehicle position estimate may be obtained from other sources in addition to (or alternative to) GNSS information. In many environments, GNSS information may not be available or may not be accurate (e.g. in urban areas or where GNSS signals may be blocked, etc.), thus other sources of positioning data may be used to estimate the position of the vehicle.

The functionality at block 920 includes obtaining observation data indicative of where the observed traffic sign is located within an image taken from the vehicle. This observation data may include coordinates of a center point, bounding box, or any of a variety of other features indicative of the location of the observed traffic sign. As previously noted, this data may be extracted from the image. Moreover, to facilitate comparison of observation and map data, the observation data may be formatted to match the format of data for the traffic sign in the 3D map data. Means for performing the functionality of block 920 may include a bus 1005, processing unit(s) 1010, sensor(s) 1040, memory 1060, and/or other components of a mobile computing system 1000 as illustrated in FIG. 10 and described in further detail below.

At block 930, the functionality comprises obtaining the 3D map data, wherein the 3D map data comprises a location, in a 3D frame, of each of one or more traffic signs in an area in which the vehicle is located. As noted above, these traffic signs may comprise candidate traffic signs which may be identified based on their distance from the position estimate of the vehicle. More particularly, traffic signs may be identified if they are within a certain threshold distance from the front of the vehicle and/or within the estimated field of view of the camera from which the image of block 920 is obtained. Means for performing the functionality of block 930 may include a bus 1005, processing unit(s) 1010, wireless communication interface 1030, sensor(s) 1040, memory 1060, and/or other components of a mobile computing system 1000 as illustrated in FIG. 10 and described in further detail below.

At block 940, a vehicle position estimate is determined based at least in part on the location information, the observation data, and the 3D map data. As explained in the embodiments above, observed traffic sign of the observation data may be associated with a traffic sign of the one or more traffic signs of block 930 for which the 3D map data includes a location. This may be used to determine the vehicle position estimate. Means for performing the functionality of block 940 may include a bus 1005, processing unit(s) 1010, memory 1060, and/or other components of a mobile computing system 1000 as illustrated in FIG. 10 and described in further detail below.

According to some embodiments, determining the vehicle position estimate may comprise, for each of the one or more traffic signs in the area, obtaining 3D coordinates indicative of a location of the respective traffic sign in a 3D frame, projecting the 3D coordinates of the respective traffic sign onto the 2D image plane of the image, and determining a 2D distance, within a 2D image plane, between the projected coordinates of the respective traffic sign and corresponding coordinates of the observed traffic sign. Embodiments may further include selecting a traffic sign from the one or more traffic signs based on the determined 2D distance. The selection of the traffic sign may be based on an order of priority obtained from the 2D distance determination which may, for example, list the closest traffic sign (to the observed traffic sign) first, the next-closest traffic signs second, and so forth. This 2D distance determination may be based on bounding boxes. For example, as shown in FIG. 5 above, map data bounding boxes 460 for each of the traffic signs may be projected onto the image plane of the camera (e.g., overlaid onto the image as shown in FIG. 5), and compared with the observed bounding box 510 of the observed traffic sign 320. Thus, according to some embodiments, the method may further comprise, for each traffic sign of the one or more traffic signs, obtaining coordinates of a bounding box for the plate of the respective traffic sign. For such embodiments, determining the 2D distance between the projected coordinates of the respective traffic sign and the corresponding coordinates of the observed traffic sign may comprise determining, for each corner of the bounding box of the respective traffic sign, the 2D distance between the respective corner and a corresponding corner of a bounding box of the observed traffic sign, as illustrated in FIG. 6. In some embodiments, selecting the traffic sign from the one or more traffic signs based on the determined 2D distance may comprise determining similarity metrics, such as an IOU, a sum of squared distance, or any combination thereof.

According to some embodiments, determining the vehicle position estimate may additionally comprise, determining a plane, within the 3D frame, of the selected traffic sign using the 3D map data for the selected traffic sign. As previously noted, the plane of the selected traffic sign can be derived from, for example, 3D coordinates of the corners of the bounding box for the selected traffic sign. Thus, the plane of the selected traffic sign may comprise a plane, in the 3D frame of the map data) in which the plate of the selected traffic sign is located.

The coordinates of the observed traffic sign may then be projected onto the plane within the 3D frame. As noted in the embodiments described above, 3D comparison of a selected traffic sign may comprise projecting corners for the observed traffic sign (and/or other coordinates of the observed traffic sign) onto the plane of the selected traffic sign. (The process may optionally involve similar projections onto the plains of other traffic signs.) A 3D distance may then be determined, within the 3D frame, between the projected coordinates of the observed traffic sign and corresponding coordinates of the selected traffic sign.

According to some embodiments, determining the vehicle position estimate may then include determining the observed traffic sign corresponds with the selected traffic sign based on the determined 3D distance, thereby “associating” the selected traffic sign to the observed traffic sign, as described in embodiments above. Associating the observed traffic sign with the selected traffic sign based on the determined 3D distance may comprise determining the 3D distance between the projected coordinates of the observed traffic sign and the corresponding coordinates of the selected traffic sign is less than a threshold distance. A determination that the distance is greater than a threshold distance may result in similar comparisons in a 3D frame between the observed traffic sign with other traffic signs. As previously discussed, the association can lead to error correction of the position estimate. As such, the vehicle position estimate may comprise a second vehicle position estimate, and embodiments may further include determining, based on the determined 3D distance, an error in a first position estimate of the vehicle, and determining the second vehicle position estimate of the vehicle based on the determined error.

As illustrated in FIGS. 7-8 and described above, the vehicle position estimate may be based on a traffic sign association made by projecting a point on the observed traffic sign as a line in the 3D frame of the 3D map data, then comparing the distance between that line and the 3D location of nearby traffic signs in the 3D map data. In such embodiments, determining the vehicle position estimate may therefore comprise projecting a point associated with the observed traffic sign as a line in the 3D frame and, for each of the one or more traffic signs in the area determining a plane, within the 3D frame, representative of the respective traffic sign and determining a distance between a point on the respective plane and the line. Determining the vehicle position estimate can also comprise selecting a traffic sign from the one or more traffic signs based on the determined distance. As noted, the plane representative of the respective traffic sign may comprise a plane defined by dimensions of a sign plate of the respective traffic sign, or a plane defined by dimensions of a bounding box of the sign plate of the respective traffic sign. In some embodiments, the point associated with the observed traffic sign comprises a center point of a sign plate of the observed traffic sign. Additionally or alternatively, the distance between the point of the respective plane and the line may comprise a 3D point-to-line distance in the 3D frame.

At block 950, the vehicle position estimate is provided to a system or device of the vehicle. As noted above, a map using unit 280 may provide the vehicle position estimate to any of a variety of devices or systems on the vehicle, including an ADAS system, automated driving system, navigation system, and/or other systems or devices that can utilize vehicle position estimates. Means for performing the functionality of block 950 may include a bus 1005, processing unit(s) 1010, wireless communication interface 1030, memory 1060, and/or other components of a mobile computing system 1000 as illustrated in FIG. 10 and described in further detail below.

FIG. 10 illustrates an embodiment of a mobile computing system 1000, which may be used to perform some or all of the functionality described in the embodiments herein, including the functionality of one or more of the blocks illustrated in FIG. 9. The mobile computing system 1000 may be located on a vehicle, and may include some or all of the components of the position estimation system 200 of FIG. 2. For example, as previously noted, the positioning unit 260 of FIG. 2 may be executed by processing unit(s) 1010; the IMU 220 and camera(s) 210 may be incorporated into sensor(s) 1040; and/or GNSS unit 230 may be included in the GNSS receiver 1080; and so forth. A person of ordinary skill in the art will appreciate where additional or alternative. It can be noted that, in some instances, components illustrated by FIG. 10 can be localized to a single physical device and/or distributed among various networked devices, which may be disposed at different physical locations (e.g., disposed at different locations of a vehicle).

The mobile computing system 1000 is shown comprising hardware elements that can be electrically coupled via a bus 1005 (or may otherwise be in communication, as appropriate). The hardware elements may include a processing unit(s) 1010 which can include without limitation one or more general-purpose processors, one or more special-purpose processors (such as digital signal processing (DSP) chips, graphics acceleration processors, application specific integrated circuits (ASICs), and/or the like), and/or other processing structure or means. As shown in FIG. 10, some embodiments may have a separate Digital Signal Processor (DSP) 1020, depending on desired functionality. Location determination and/or other determinations based on wireless communication may be provided in the processing unit(s) 1010 and/or wireless communication interface 1030 (discussed below). The mobile computing system 1000 also can include one or more input devices 1070, which can include without limitation a keyboard, touch screen, a touch pad, microphone, button(s), dial(s), switch(es), and/or the like; and one or more output devices 1015, which can include without limitation a display, light emitting diode (LED), speakers, and/or the like.

The mobile computing system 1000 may also include a wireless communication interface 1030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX™ device, a Wide Area Network (WAN) device and/or various cellular devices, etc.), and/or the like, which may enable the mobile computing system 1000 to communicate data (e.g., to/from a server for crowdsourcing, as described herein) via the one or more data communication networks. The communication can be carried out via one or more wireless communication antenna(s) 1032 that send and/or receive wireless signals 1034.

Depending on desired functionality, the wireless communication interface 1030 may comprise separate transceivers to communicate terrestrial transceivers, such as wireless devices, base stations, and/or access points. The mobile computing system 1000 may communicate with different data networks that may comprise various network types. For example, a WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16) network, and so on. A CDMA network may implement one or more radio access technologies (RATs) such as CDMA2000, Wideband CDMA (WCDMA), and so on. Cdma2000 includes IS-95, IS-2000, and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from the Third Generation Partnership Project (3GPP). Cdma2000 is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or Wireless Personal Area Network (WPAN).

The mobile computing system 1000 can further include sensor(s) 1040. Sensors 1040 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to complement and/or facilitate the position determination described herein, in some instances. In some embodiments, one or more cameras included in the sensor(s) 1040 may be used to obtain the images as described in the embodiments presented herein used by the VEPP unit 270, perception unit 240, and the like. Additionally or alternatively, inertial sensors included in the sensor(s) 1040 may be used to determine the orientation of the camera and/or mobile device, as described in the embodiments above.

Embodiments of the mobile computing system 1000 may also include a GNSS receiver 1080 capable of receiving signals 1084 from one or more GNSS satellites (e.g., SVs 140) using an antenna 1082 (which could be the same as antenna 1032). Positioning based on GNSS signal measurement can be utilized to complement and/or incorporate the techniques described herein. The GNSS receiver 1080 can extract a position of the mobile computing system 1000, using conventional techniques, from GNSS SVs of a GNSS system (e.g., SVs 140 of FIG. 1), such as Global Positioning System (GPS), Galileo, Glonass, Quasi-Zenith Satellite System (QZSS) over Japan, Indian Regional Navigational Satellite System (IRNSS) over India, Beidou over China, and/or the like. Moreover, the GNSS receiver 1080 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

The mobile computing system 1000 may further include and/or be in communication with a memory 1060. The memory 1060 can include, without limitation, local and/or network accessible storage, a disk drive, a drive array, an optical storage device, a solid-state storage device, such as a Random Access Memory (RAM), and/or a Read-Only Memory (ROM), which can be programmable, flash-updateable, and/or the like. Such storage devices may be configured to implement any appropriate data stores, including without limitation, various file systems, database structures, and/or the like.

The memory 1060 of the mobile computing system 1000 also can comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the mobile computing system 1000 (and/or processing unit(s) 1010 or DSP 1020 within mobile computing system 1000). In an aspect, then, such code and/or instructions can be used to configure and/or adapt a general purpose computer (or other device) to perform one or more operations in accordance with the described methods.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

What is claimed is:

1. A method of vehicle position estimation based on an observed traffic sign and 3D map data for the observed traffic sign, the method comprising:
obtaining location information for the vehicle;
obtaining observation data indicative of where the observed traffic sign is located within an image of the observed traffic sign taken from a vehicle;
obtaining the 3D map data, wherein the 3D map data comprises a location, in a 3D frame, of each of one or more traffic signs in an area in which the vehicle is located;
determining a vehicle position estimate based at least in part on the location information, the observation data, and the 3D map data; and
providing the vehicle position estimate to a system or device of the vehicle.

2. The method of claim 1, wherein determining the vehicle position estimate comprises:
projecting a point associated with the observed traffic sign as a line in the 3D frame;
for each of the one or more traffic signs in the area:
determining a plane, within the 3D frame, representative of the respective traffic sign, and
determining a distance between a point on the respective plane and the line; and
selecting a traffic sign from the one or more traffic signs based on the determined distance.

3. The method of claim 2, wherein the plane representative of the respective traffic sign comprises:
a plane defined by dimensions of a sign plate of the respective traffic sign, or
a plane defined by dimensions of a bounding box of the sign plate of the respective traffic sign.

4. The method of claim 2, wherein the point associated with the observed traffic sign comprises a center point of a sign plate of the observed traffic sign.

5. The method of claim 2, wherein the distance between the point of the respective plane and the line comprises a 3D point-to-line distance in the 3D frame.

6. The method of claim 1, wherein determining the vehicle position estimate comprises:
for each of the one or more traffic signs in the area:
obtaining 3D coordinates indicative of a location of the respective traffic sign in the 3D frame,
projecting the 3D coordinates of the respective traffic sign onto a 2D image plane of the image, and
determining a 2D distance, within a 2D image plane, between the projected coordinates of the respective traffic sign and corresponding coordinates of the observed traffic sign;
selecting a traffic sign from the one or more traffic signs based on the determined 2D distance;
determining a plane, within the 3D frame, of the selected traffic sign using the 3D map data for the selected traffic sign;
projecting the coordinates of the observed traffic sign onto the plane within the 3D frame;
determining a 3D distance, within the 3D frame, between the projected coordinates of the observed traffic sign and corresponding coordinates of the selected traffic sign;
determining the observed traffic sign corresponds with the selected traffic sign based on the determined 3D distance; and
determining the vehicle position estimate based, at least in part, on the location of the selected traffic sign in the 3D frame.

7. The method of claim 6, further comprising:
determining, based on the determined 3D distance, an error in an initial position estimate of the vehicle obtained from the location information; and
determining the vehicle position estimate based on the determined error.

8. The method of claim 6, wherein, for each of the one or more traffic signs in the area, obtaining the 3D coordinates indicative of the location the respective traffic sign in the 3D frame comprises obtaining coordinates of a bounding box for a plate of the respective traffic sign.

9. The method of claim 8, wherein determining the 2D distance between the projected coordinates of the respective traffic sign and the corresponding coordinates of the observed traffic sign comprises determining, for each corner of the bounding box of the respective traffic sign, the 2D distance between the respective corner and a corresponding corner of a bounding box of the observed traffic sign.

10. The method of claim 6, wherein determining the observed traffic sign corresponds with the selected traffic sign based on the determined 3D distance comprises determining the 3D distance between the projected coordinates of the observed traffic sign and the corresponding coordinates of the selected traffic sign is less than a threshold distance.

11. The method of claim 6, wherein selecting the selected traffic sign from the one or more traffic signs based on the determined 2D distance further comprises determining an intersection-over-union (IOU), or a sum of squared distance, or any combination thereof.

12. The method of claim 1, wherein the location information comprises:
Global Navigation Satellite System (GNSS) information;
wireless terrestrial location information; or
Visual Inertial Odometry (VIO) information; or
any combination thereof.

13. A mobile computing system comprising:
a memory; and
one or more processing units communicatively coupled with the memory and configured to:
obtaining location information for a vehicle;
obtain observation data indicative of where an observed traffic sign is located within an image of the observed traffic sign taken from the vehicle;
obtain 3D map data, wherein the 3D map data comprises a location, in a 3D frame, of each of one or more traffic signs in an area in which the vehicle is located;
determine a vehicle position estimate based at least in part on the location information, the observation data, and the 3D map data; and
provide the vehicle position estimate to a system or device of the vehicle.

14. The mobile computing system of claim 13 wherein, to determine the vehicle position estimate, the one or more processing units are configured to:
project a point associated with the observed traffic sign as a line in the 3D frame;
for each of the one or more traffic signs in the area:
determine a plane, within the 3D frame, representative of the respective traffic sign, and
determine a distance between a point on the respective plane and the line; and
select a traffic sign from the one or more traffic signs based on the determined distance.

15. The mobile computing system of claim 14 wherein, to determine the plane representative of the respective traffic sign, the one or more processing units are configured to determine:
a plane defined by dimensions of a sign plate of the respective traffic sign, or
a plane defined by dimensions of a bounding box of the sign plate of the respective traffic sign.

16. The mobile computing system of claim 14 wherein, to determine the point associated with the observed traffic sign, the one or more processing units are configured to determine a center point of a sign plate of the observed traffic sign.

17. The mobile computing system of claim 14 wherein, to determine the distance between the point of the respective plane and the line, the one or more processing units are configured to determine a 3D point-to-line distance in the 3D frame.

18. The mobile computing system of claim 13 wherein, to determine the vehicle position estimate, the one or more processing units are configured to:
for each of the one or more traffic signs in the area:
obtain 3D coordinates indicative of a location of the respective traffic sign in the 3D frame,
project the 3D coordinates of the respective traffic sign onto a 2D image plane of the image, and
determine a 2D distance, within a 2D image plane, between the projected coordinates of the respective traffic sign and corresponding coordinates of the observed traffic sign;
select a traffic sign from the one or more traffic signs based on the determined 2D distance;
determine a plane, within the 3D frame, of the selected traffic sign using the 3D map data for the selected traffic sign;
project the coordinates of the observed traffic sign onto the plane within the 3D frame;
determine a 3D distance, within the 3D frame, between the projected coordinates of the observed traffic sign and corresponding coordinates of the selected traffic sign;
determine the observed traffic sign corresponds with the selected traffic sign based on the determined 3D distance; and
determine the vehicle position estimate based, at least in part, on the location of the selected traffic sign in the 3D frame.

19. The mobile computing system of claim 18 wherein, to determine the vehicle position estimate, the one or more processing units are configured to:
determine, based on the determined 3D distance, an error in an initial position estimate of the vehicle obtained from the location information; and
determine the vehicle position estimate based on the determined error.

20. The mobile computing system of claim 18, wherein the one or more processing units are configured to, for each of the one or more traffic signs in the area, obtain the 3D coordinates indicative of the location the respective traffic sign in the 3D frame comprises obtaining coordinates of a bounding box for a plate of the respective traffic sign.

21. The mobile computing system of claim 20, wherein, to determine the 2D distance between the projected coordinates of the respective traffic sign and the corresponding coordinates of the observed traffic sign, the one or more processing units are configured to determine, for each corner of the bounding box of the respective traffic sign, the 2D distance between the respective corner and a corresponding corner of a bounding box of the observed traffic sign.

22. The mobile computing system of claim 18, wherein, to determine the observed traffic sign corresponds with the selected traffic sign based on the determined 3D distance, the one or more processing units are configured to determine the 3D distance between the projected coordinates of the observed traffic sign and the corresponding coordinates of the selected traffic sign is less than a threshold distance.

23. The mobile computing system of claim 18, wherein, to select the selected traffic sign from the one or more traffic signs based on the determined 2D distance, the one or more processing units are configured to determine an intersection-over-union (IOU), or a sum of squared distance, or any combination thereof.

24. A device for estimating vehicle position based on an observed traffic sign and 3D map data for the observed traffic sign, the device comprising:
means for obtaining location information for the vehicle;
means for obtaining observation data indicative of where the observed traffic sign is located within an image of the observed traffic sign taken from a vehicle;
means for obtaining the 3D map data, wherein the 3D map data comprises a location, in a 3D frame, of each of one or more traffic signs in an area in which the vehicle is located;
means for determining a vehicle position estimate based at least in part on the location information, the observation data, and the 3D map data; and
means for providing the vehicle position estimate to a system or device of the vehicle.

25. The device of claim 24, wherein, to determine the vehicle position estimate, the device further comprises:
means for projecting a point associated with the observed traffic sign as a line in the 3D frame;
means for, for each of the one or more traffic signs in the area:
determining a plane, within the 3D frame, representative of the respective traffic sign, and
determining a distance between a point on the respective plane and the line; and
means for selecting a traffic sign from the one or more traffic signs based on the determined distance.

26. The device of claim 25, wherein, to determine the distance between the point of the respective plane and the line, the device further comprises means for determining a 3D point-to-line distance in the 3D frame.

27. The device of claim 24, wherein, to determine the vehicle position estimate, the device further comprises:
means for, for each of the one or more traffic signs in the area:
obtaining 3D coordinates indicative of a location of the respective traffic sign in the 3D frame,
projecting the 3D coordinates of the respective traffic sign onto a 2D image plane of the image, and
determining a 2D distance, within a 2D image plane, between the projected coordinates of the respective traffic sign and corresponding coordinates of the observed traffic sign;
means for selecting a traffic sign from the one or more traffic signs based on the determined 2D distance;
means for determining a plane, within the 3D frame, of the selected traffic sign using the 3D map data for the selected traffic sign;
means for projecting the coordinates of the observed traffic sign onto the plane within the 3D frame;
means for determining a 3D distance, within the 3D frame, between the projected coordinates of the observed traffic sign and corresponding coordinates of the selected traffic sign;
means for determining the observed traffic sign corresponds with the selected traffic sign based on the determined 3D distance; and
means for determining the vehicle position estimate based, at least in part, on the location of the selected traffic sign in the 3D frame.

28. A non-transitory computer-readable medium having instructions stored thereby for estimating vehicle position based on an observed traffic sign and 3D map data for the observed traffic sign, wherein the instructions, when executed by one or more processing units, cause the one or more processing units to:
obtain location information for the vehicle;
obtain observation data indicative of where the observed traffic sign is located within an image of the observed traffic sign taken from a vehicle;
obtain the 3D map data, wherein the 3D map data comprises a location, in a 3D frame, of each of one or more traffic signs in an area in which the vehicle is located;
determine a vehicle position estimate based at least in part on the location information, the observation data, and the 3D map data; and
provide the vehicle position estimate to a system or device of the vehicle.

29. The non-transitory computer-readable medium of claim 28, wherein, to determine the vehicle position estimate, the instructions, when executed by one or more processing units, further cause the one or more processing units to:
project a point associated with the observed traffic sign as a line in the 3D frame;
for each of the one or more traffic signs in the area:
determine a plane, within the 3D frame, representative of the respective traffic sign, and
determine a distance between a point on the respective plane and the line; and
select a traffic sign from the one or more traffic signs based on the determined distance.

30. The non-transitory computer-readable medium of claim 28, wherein, to determine the vehicle position estimate, the instructions, when executed by one or more processing units, further cause the one or more processing units to:
for each of the one or more traffic signs in the area:
obtain 3D coordinates indicative of a location of the respective traffic sign in the 3D frame,
project the 3D coordinates of the respective traffic sign onto a 2D image plane of the image, and
determine a 2D distance, within a 2D image plane, between the projected coordinates of the respective traffic sign and corresponding coordinates of the observed traffic sign;
select a traffic sign from the one or more traffic signs based on the determined 2D distance;
determine a plane, within the 3D frame, of the selected traffic sign using the 3D map data for the selected traffic sign;
project the coordinates of the observed traffic sign onto the plane within the 3D frame;
determine a 3D distance, within the 3D frame, between the projected coordinates of the observed traffic sign and corresponding coordinates of the selected traffic sign;
determine the observed traffic sign corresponds with the selected traffic sign based on the determined 3D distance; and
determine the vehicle position estimate based, at least in part, on the location of the selected traffic sign in the 3D frame.
